(19) United States
(12) Patent Application Publication
(10) Pub. No.: US 2012/0023220 A1
(43) Pub. Date: Jan. 26, 2012

(54) AUTOMATIC TESTING SYSTEM OF DYNAMIC HOST CONFIGURATION PROTOCOL SERVER

(76) Inventors: Chih-Ming Ma, Hsinchu County (TW); Tzu-Hang Hsu, Taichung County (TW)

(21) Appl. No.: 12/840,663

(22) Filed: Jul. 21, 2010

(51) Int. Cl. G06F 15/173

(52) U.S. Cl. 709/224

(57) ABSTRACT

An automatic testing system of a dynamic host configuration protocol server is used for performing a quality assurance test of the dynamic host configuration protocol server, and the automatic testing system includes a packet processing unit, an automatic testing module and an operating unit connected to the automatic testing module. The packet processing unit is used for generating, analyzing and transmitting a plurality of packets, and the automatic testing module is connected to the packet processing unit and the dynamic host configuration protocol server, and the packet processing unit tests and analyzes a packet to the dynamic host configuration protocol server, and the operating unit is provided for a user to operate and set up the automatic testing module, such that the testing system can test the dynamic host configuration protocol server automatically, and prevent errors and damaged caused by inexperience and negligence of a manual testing.

### FIELD OF THE INVENTION

The present invention relates to an automatic testing system of a network system, and more particularly to a testing system of a dynamic host configuration protocol server.

### BACKGROUND OF THE INVENTION

Network has played an important role in our daily life. As the network population increases, and every computer (or other network device) connected to the Internet requires an IP address, the present Internet Protocol version 4 (IPv4) no longer can meet the demand anymore. To overcome the problem of insufficient IP addresses, research and development engineers provide two main types of solutions, and one type of solution relates to the use of a virtual IP address with a network address translation (NAT) technique. In local area networks (LAN), a LAN server usually uses virtual IP addresses. In external networks, the server usually uses the NAT technique that communicates with the outside by a set of physical IP addresses in order to reduce the use of physical addresses. Another type of solution relates to the use of a dynamic host configuration protocol (DHCP) that adopts the concept of allocating the IP addresses dynamically and uses a limited number of IP addresses alternately for users.

The application of the DHCP technology requires a DHCP server installed at a network room and a client's network device. Regardless of the DHCP server or the client's network device, both must go through detailed and strict tests before leaving a factory to assure their quality. As disclosed in U.S. Pat. No. 7,596,095, a “Network device test system and method for testing network device” uses a testing system to monitor and test a client's network device to assure the quality of the network device before leaving the factory.

However, present DHCP server products usually do not come with an effective automatic testing instrument, and product testing engineers can only perform tests manually. The function of the DHCP server is complicated in communicating between devices, and the testing engineers may be unable to detect an error in a packet due to inexperience or negligence, and damages may be resulted from misjudgments or errors of a test report.

### SUMMARY OF THE INVENTION

Therefore, the primary objective of the present invention is to prevent testing engineers from failing to detect errors in packets due to inexperience or negligence, and avoid damages resulted from misjudgments or errors in filling a test report.

To achieve the foregoing objective, the present invention provides an automatic testing system of a dynamic host configuration protocol server for performing a quality assurance test to the dynamic host configuration protocol server, and the automatic testing system comprises a packet processing unit, an automatic testing module and an operating unit connected to the automatic testing module. The packet processing unit is used for generating, analyzing and transmitting a plurality of packets, and the automatic testing module is connected to the packet processing unit and the dynamic host configuration protocol server, and the automatic testing module tests and analyzes the dynamic host configuration protocol server through the packet processing unit, and the operating unit is provided for a user to operate and set up the automatic testing module.

As described above, the present invention performs a functional test to the dynamic host configuration protocol server by the automatic testing module, not only capable of testing the dynamic host configuration protocol server before leaving the factory, but also capable of performing a functional test to assure the quality of the dynamic host configuration protocol server after a firmware update or repair and maintenance of the server. In addition, the automatic testing system of the present invention can avoid misjudgments caused by the inexperience or negligence of the testing engineers, or errors in filling the test report, and prevent damages incurred to manufacturers due to a low overall quality. Compared with the manual testing method, the automatic testing system of the present invention not only provides high accuracy, but also reduces the quality inspection time.

### BRIEF DESCRIPTION OF THE DRAWINGS

FIG. 1 is a schematic block diagram of a preferred embodiment of the present invention.

FIG. 2 is a flow chart of a testing procedure in accordance with a preferred embodiment of the present invention.

FIG. 3 is a report of test results in accordance with a preferred embodiment of the present invention.

### DETAILED DESCRIPTION OF THE PREFERRED EMBODIMENTS

The technical contents of the present invention will now be described in more detail hereinafter with reference to the accompanying drawings that show various embodiments of the invention.

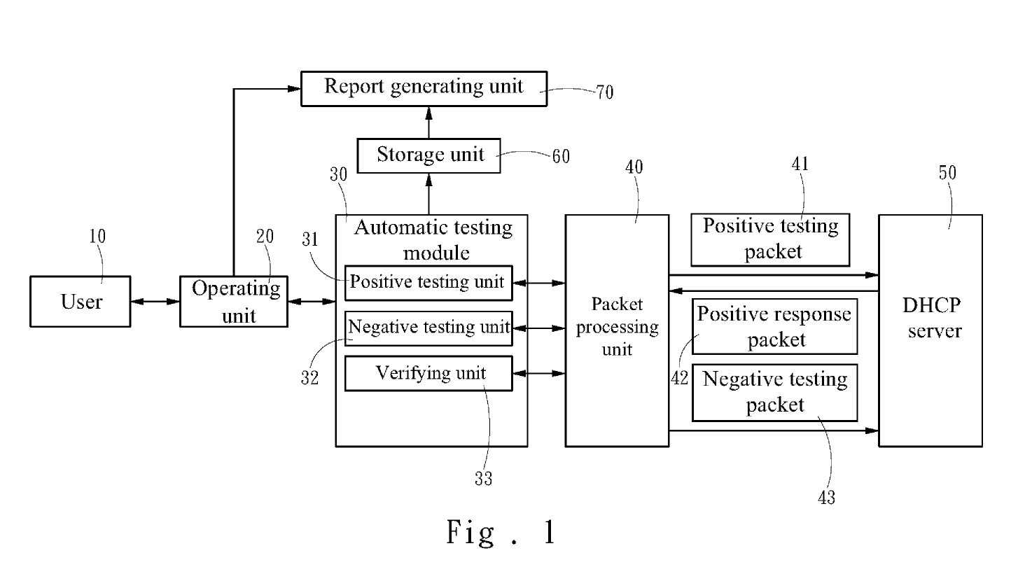

With reference to FIG. 1 for a schematic block diagram of a preferred embodiment of the present invention, an automatic testing system of a dynamic host configuration protocol (DHCP) server used for performing a quality assurance test to the DHCP server 50, and the automatic testing system comprises: a packet processing unit 40, an automatic testing module 30 and an operating unit 20 connected to the automatic testing module 30. The packet processing unit 40 is provided for generating, analyzing and transmitting a plurality of packets, and the automatic testing module 30 is connected to the packet processing unit 40 and the DHCP server 50, for testing and analyzing the DHCP server 50 through the packet processing unit 40, and the operating unit 20 is provided for a user 10 to operate and set up the automatic testing module 30.

For details, the automatic testing module 30 contains a positive testing unit 31, a negative testing unit 32 and a verifying unit 33. The positive testing unit 31 generates and transmits a positive testing packet 41 to the DHCP server 50 through the packet processing unit 40, and the packet processing unit 40 analyzes and transmits a positive response packet 42 returned from the DHCP server 50 to the positive testing unit 31 in order to check whether or not a positive response of the DHCP server 50 is correct. The negative testing unit 32 generates and transmits a negative testing packet 43 to the DHCP server 50 through the packet processing unit 40, and the DHCP server 50 have to determine that the negative testing packet 43 is an invalid packet and then discard the negative testing packet 43, and continue to operate normally. The verifying unit 33 is provided for verifying the correctness of a returned packet of the DHCP server 50.

The automatic testing system of a DHCP server of the present invention further comprises a storage unit 60 and a report generating unit 70, and the storage unit 60 is connected to the automatic testing module 30 and the operating unit 20, and the report generating unit 70 is connected to the operating unit 20, the storage unit 60 and the automatic testing module 30. The storage unit 60 is provided for storing test information from the automatic testing module 30, and the report generating unit 70 is provided for receiving information from the automatic testing module 30 directly to generate a report, or provided for a user 10 to select information from the storage unit 60 through the operating unit 20 and generate a report by the report generating unit 70.

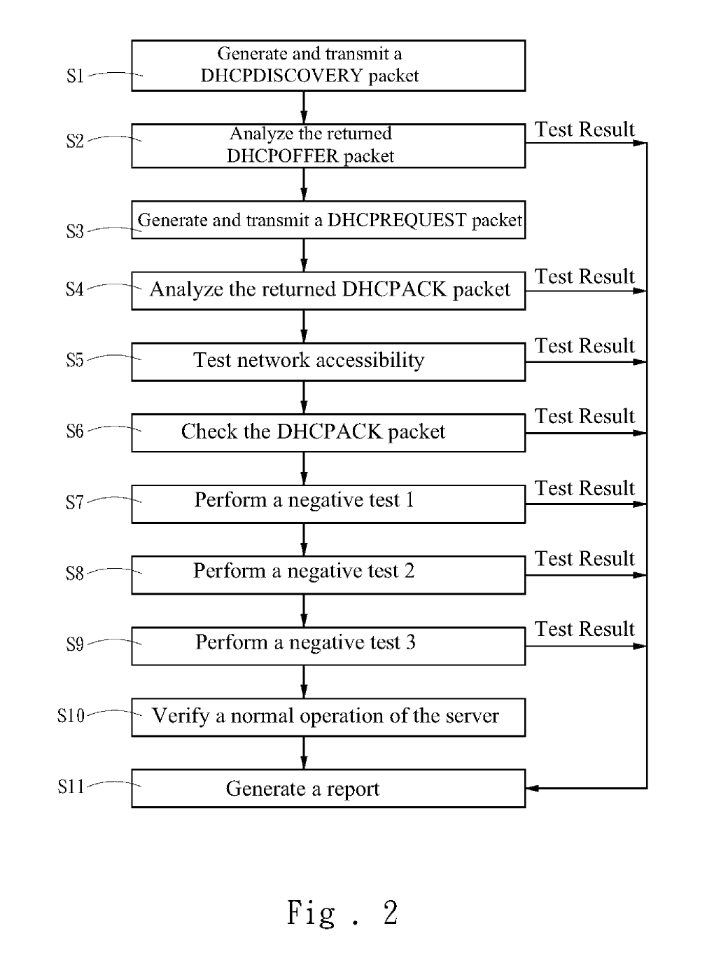

With reference to FIG. 2 for a flow chart of a testing procedure of a preferred embodiment of the present invention together with FIG. 1, the testing procedure comprises eleven steps S1˜S11 as described below:
S1: Generate and transmit a DHCPDISCOVERY packet, and the positive testing unit 31 generates the DHCPDISCOVERY packet based on a RFC 2131 standard to the DHCP server 50 through the packet processing unit 40, and wait for a corresponding DHCPOFFER packet, wherein the DHCPDISCOVERY packet and the DHCPOFFER packet are the positive testing packet 41 and the positive response packet 42 respectively.

S2: Analyze the returned DHCPOFFER packet, and the packet processing unit 40 analyses and transmits the DHCPOFFER packet to the positive testing unit 31 after receiving the DHCPOFFER packet, and the positive testing unit 31 checks whether or not a Transaction ID in the DHCPOFFER packet is identical to a Transaction ID in the DHCPDISCOVERY packet, and if the Transaction IDs are identical, it indicates a normal test result, and if the Transaction IDs are not identical, it indicates an abnormal test result.

S3: Generate and transmit a DHCPREQUEST packet, and the positive testing unit 31 generates the DHCPREQUEST packet to the DHCP server 50 based on a RFC 2131 standard through the packet processing unit 40, and wait for a corresponding DHCPACK packet, wherein the DHCPREQUEST packet and the DHCPACK packet are the positive testing packet 41 and the positive response packet 42 respectively.

S4: Analyze the returned DHCPACK packet, and the packet processing unit 40 analyses and transmits the DHCPOFFER packet after receiving the DHCPOFFER packet, wherein the positive testing unit 31 checks whether or not a Transaction ID in the DHCPACK packet is identical to a Transaction ID in the DHCPREQUEST packet, and examine a yiaddr field, and verify whether or not a correct Internet address is retrieved, and if both of the aforementioned verifications are correct, then the testing result is normal, or else the testing result is abnormal.

S5: Test network accessibility, and check whether or not the Internet address retrieved by the DHCP server 50 can be used for performing a network service access.

S6: Check the DHCPACK packet, and the verifying unit 33 performs analyzes and verifies the correctness of a server identifier (server ID), a domain name sever (DNS) and a lease time according to the DHCPACK packet, and verify whether or not the retrieved Internet address falls within a correct range.

S7: Perform a negative test 1, wherein the negative testing packet 43 is a DHCPDISCOVERY error containing packet based on a RFC 2131 standard, and transmit the DHCPDISCOVERY error containing packet containing an invalid code of op code=0x03 to the DHCP server 50, and it is noteworthy to point out that the correct value of the op code should be 0x01, and a correct response refers to the DHCP server 50 capable of discarding the DHCPDISCOVERY error containing packet which has an error contained in the field, not returning a DHCPOFFER packet, and continuing to operate normally.

S8: Perform a negative test 2, and transmit a DHCPDISCOVERY error containing packet containing Flag=0x0001 to the DHCP server 50, wherein the correct value of Flag should be 0x8000, and a correct response refers to the DHCP server 50 capable of discarding the DHCPDISCOVERY error containing packet which has an error contained in the field, not returning a DHCPOFFER packet, and continuing to the operate normally.

S9: Perform a negative test 3, and transmit a DHCPDISCOVERY error containing packet containing Ciaddr=224.168.0.1 to the DHCP server 50, wherein the correct value of Ciaddr should be 0.0.0.0, and a correct response refers to the DHCP server 50 capable of discarding the DHCPDISCOVERY error containing packet which has an error contained in the field, not returning a DHCPOFFER packet, and continuing to operate normally.

S10: Verify a normal operation of the server, and since after the DHCP server 50 receives a DHCPDISCOVERY error containing packet that contains an error in the field, the DHCPOFFER packet will not be returned, and the DHCP server 50 will not return the DHCPOFFER packet in a breakdown, and thus it is necessary to repeat the steps S1˜S6 again to confirm that the DHCP server 50 discards the invalid packet under a normal operation, after the aforementioned negative test is completed.

S11: Generate a report, wherein the report generating unit 70 generates a test report provided for verifying by a testing engineer after the automatic testing module 30 performs the test.

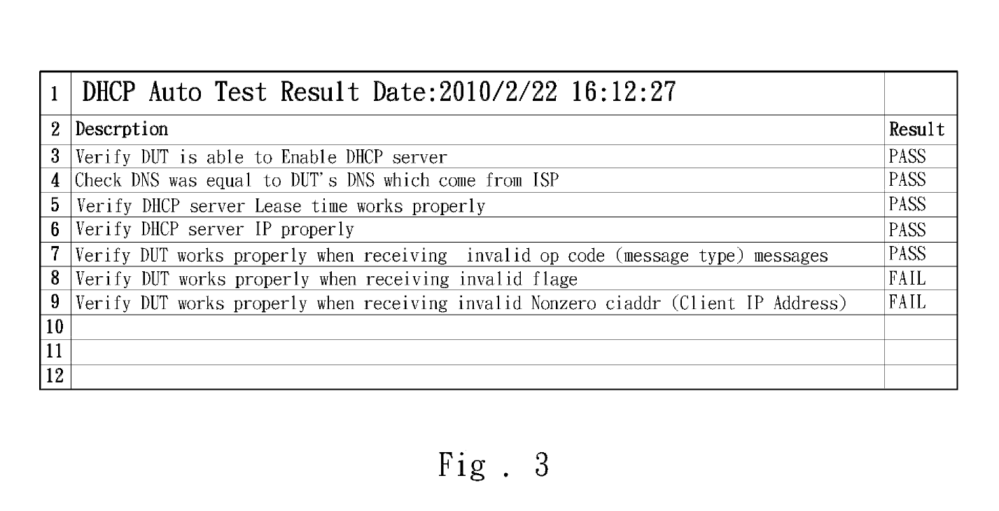

With reference to FIG. 3 for a schematic view of a test report in accordance with a preferred embodiment of the present invention, if the test result is normal, PASS will be shown in the final result field (Result), and if the test result is abnormal, FAIL will be shown in the final result field (Result), wherein the last two items are negative testing, and after the DHCP server 50 has received a DHCPDISCOVERY error packet containing an invalid field, the DHCPDISCOVERY packet should be discarded, and a DHCPOFFER packet will not be returned, but the DHCP server 50 returns a DHCPOFFER packet, such that FAIL will be shown in the test report since the test result is abnormal.

It is noteworthy to point out that DHCPDISCOVERY, DHCPOFFER, DHCPREQUEST, DHCPACK, Transaction ID, yiaddr and Ciaddr mentioned in the present invention are common terminologies to persons ordinarily skilled in the art, and thus will not be described further here.

In summation of the description above, the present invention performs a function test to the DHCP server 50 through the automatic testing module 30, not only capable of testing the DHCP server 50 before leaving the factory, but also capable of performing a functional test to assure the quality of the DHCP server 50 after firmware update or repair and maintenance.

In addition, the automatic testing system of the present invention can avoid misjudgments caused by the inexperience or negligence of a testing engineer, or errors occurred in filling a testing report, and prevent damages incurred to manufacturers due to low overall quality. The storage unit 60 and the report generating unit 70 are provided for storing and printing the testing results to facilitate follow-ups and processing. Compared with the manual testing method, the automatic testing system of the present invention not only provides the high accuracy, but also reduces the quality inspection time.

While the invention has been described by means of specific embodiments, numerous modifications and variations could be made thereto by those skilled in the art without departing from the scope and spirit of the invention set forth in the claims.

What is claimed is:

1. An automatic testing system of a dynamic host configuration protocol server, for performing a quality assurance test to the dynamic host configuration protocol server, and the automatic testing system comprising:
a packet processing unit, for generating, analyzing and transmitting a plurality of packets;
an automatic testing module, connected to the packet processing unit and the dynamic host configuration protocol server, for testing and analyzing the dynamic host configuration protocol server through the packet processing unit; and
an operating unit, connected to the automatic testing module, and provided for a user to operate and set up the automatic testing module.

2. The automatic testing system of a dynamic host configuration protocol server according to claim 1, wherein the automatic testing module includes a positive testing unit and a negative testing unit, and the positive testing unit checks whether or not a positive response from the dynamic host configuration protocol server is correct through the packet processing unit, and the negative testing unit checks whether or not a negative response from the dynamic host configuration protocol server is correct through the packet processing unit.

3. The automatic testing system of a dynamic host configuration protocol server according to claim 2, wherein the positive testing unit generates and transmits a positive testing packet to the DHCP server through the packet processing unit, and the packet processing unit analyzes and transmits a positive response packet returned from the dynamic host configuration protocol server to the positive testing unit.

4. The automatic testing system of a dynamic host configuration protocol server according to claim 3, wherein the positive testing packet is a DHCPDISCOVERY packet based on a RFC 2131 standard, and the positive response packet is a DHCPOFFER packet.

5. The automatic testing system of a dynamic host configuration protocol server according to claim 4, wherein the packet processing unit analyzes the DHCPOFFER packet after receiving the DHCPOFFER packet, and the positive testing unit checks whether or not a Transaction ID in the DHCPOFFER packet is identical to a Transaction ID in the DHCPDISCOVERY packet.

6. The automatic testing system of a dynamic host configuration protocol server according to claim 3, wherein the positive testing packet is a DHCPREQUEST packet according to a RFC 2131 standard, and the positive response packet is a DHCPACK packet.

7. The automatic testing system of a dynamic host configuration protocol server according to claim 6, wherein the packet processing unit analyzes the DHCPACK packet after receiving the DHCPACK packet, and the positive testing unit checks whether or not a Transaction ID in the DHCPACK packet is identical to a Transaction ID in the DHCPREQUEST packet, and inspects a yiaddr field, and verifies whether or not a correct Internet address is obtained.

8. The automatic testing system of a dynamic host configuration protocol server according to claim 3, wherein the positive testing unit checks a network service accessibility of the Internet address obtained by the dynamic host configuration protocol server.

9. The automatic testing system of a dynamic host configuration protocol server according to claim 2, wherein the negative testing unit generates and transmits a negative testing packet to the dynamic host configuration protocol server through the packet processing unit.

10. The automatic testing system of a dynamic host configuration protocol server according to claim 9, wherein the negative testing packet is a DHCPDISCOVERY error containing packet based on a RFC 2131 standard.

11. The automatic testing system of a dynamic host configuration protocol server according to claim 1, wherein the automatic testing module includes a verifying unit for verifying the correctness of a returned packet from the dynamic host configuration protocol server.

12. The automatic testing system of a dynamic host configuration protocol server according to claim 1, further comprising a storage unit for storing test information, and the storage unit being connected to the automatic testing module and the operating unit.

13. The automatic testing system of a dynamic host configuration protocol server according to claim 12, further comprising a report generating unit for generating a test result, and the report generating unit being connected to the operating unit, the storage unit and the automatic testing module.

14. The automatic testing system of a dynamic host configuration protocol server according to claim 1, wherein the automatic testing module is connected to the dynamic host configuration protocol server through a cable network or a wireless network.
